(19) United States
(12) Patent Application Publication
(10) Pub. No.: US 2016/0201766 A1
(43) Pub. Date: Jul. 14, 2016

(54) AUTOMATIC TRANSMISSION APPARATUS

(71) Applicants: AISIN AW CO., LTD., Anjo-shi, Aichi-ken (JP); TOYOTA JIDOSHA KABUSHIKI KAISHA, Toyota-shi, Aichi-ken (JP)

(72) Inventors: Takayoshi KATO, Handa (JP); Takashi MORIMOTO, Gamagori (JP); Toshihiko AOKI, Anjo (JP); Hiroshi KATO, Kariya (JP); Satoru KASUYA, Nishio (JP); Masaru MORISE, Nukata (JP); Shinji OITA, Toyota (JP)

(73) Assignees: AISIN AW CO., LTD., Anjo-shi, Aichi-ken (JP); TOYOTA JIDOSHA KABUSHIKI KAISHA, Toyota-shi, Aichi-ken (JP)

(21) Appl. No.: 14/900,958

(22) PCT Filed: Mar. 27, 2014
(86) PCT No.: PCT/JP2014/058992

§ 371 Date: Dec. 22, 2015

(30) Foreign Application Priority Data
Jul. 26, 2013 (JP) 2013-155808

(51) Int. Cl. F16H 3/66

(52) U.S. Cl. CPC F16H 3/66; F16H 2200/0069; F16H 2200/2012; F16H 2200/2046; F16H 2200/2064; F16H 2200/2094

(57) ABSTRACT

An automatic transmission apparatus that includes a first planetary gear mechanism, a second planetary gear mechanism, a third planetary gear mechanism, a fourth planetary gear mechanism, a first coupling element, a second coupling element, a third coupling element, a fourth coupling element, a first clutch, a second clutch, a third clutch, a fourth clutch, a first brake and a second brake.

### TECHNICAL FIELD

The present invention relates to an automatic transmission apparatus that shifts power input to an input member and outputs the shifted power to an output member.

### BACKGROUND ART

An automatic transmission apparatus of this type has heretofore been proposed which can establish seven forward speeds and a reverse speed using four planetary gear mechanisms and six engagement elements including three clutches and three brakes (refer to Patent Document 1, for example). An automatic transmission apparatus of the conventional example as a background art includes, as the four planetary gear mechanisms, a double-pinion type planetary gear mechanism having a gear ratio (the number of teeth of the sun gear/the number of teeth of the ring gear in the planetary gear mechanism) of 0.544 and three single-pinion type planetary gear mechanisms having gear ratios of 0.439, 0.310, and 0.535, and establishes the seven forward speeds and the reverse speed by engaging two engagement elements of the six engagement elements and disengaging four engagement elements of the six engagement elements. In this case, the first speed as the lowest shift speed has a gear ratio of 4.222, and the seventh forward speed as the highest shift speed has a gear ratio of 0.695, so that a gear ratio range (the gear ratio of the lowest shift speed/the gear ratio of the highest shift speed) of 6.06 is obtained.

### RELATED ART DOCUMENTS

### Patent Documents

Patent Document 1: Japanese Patent Application Publication No. 2010-203536 (JP 2010-203536 A)

### SUMMARY OF THE INVENTION

A larger gear ratio range (the gear ratio of the lowest shift speed/the gear ratio of the highest shift speed) of the automatic transmission apparatus can provide both better fuel economy and better acceleration performance of a vehicle including the automatic transmission apparatus, so that the gear ratio range is preferably large. However, a large step ratio (the gear ratio of the one-step lower shift speed/the gear ratio of the current shift speed) impairs a smooth shift feel around the time of shifting. Therefore, the automatic transmission apparatus preferably has a large number of forward shift speeds to perform shifting to optimal gear stages.

As planetary gear mechanisms included in an automatic transmission apparatus, single-pinion type planetary gear mechanisms and double-pinion type planetary gear mechanisms have been known. The double-pinion type planetary gear mechanisms include two rows of pinion gears in a radial direction. As a result, the pinion gears mesh with each other, so that the meshing loss of gears is increased, and thus the transmission efficiency of power is reduced compared to the case of the single-pinion type planetary gear mechanisms. Because of having the two rows of pinion gears in the radial direction, the double-pinion type planetary gear mechanisms have a larger number of components, lower assemblability, a higher cost burden, and a larger mass than in the case of the single-pinion type planetary gear mechanisms. Therefore, as many as possible of the four planetary gear mechanisms included in the automatic transmission apparatus are preferably the single-pinion type planetary gear mechanisms.

The engagement elements of the automatic transmission apparatus generate a drag loss due to slight contact even while disengaged, so that the drag loss reduces the transmission efficiency of power to a lower level as a larger number of engagement elements are disengaged when a shift speed is established. Therefore, the number of engagement elements to be disengaged when each shift speed is established is preferably small.

It is a primary object of the present invention to propose a new automatic transmission apparatus that can establish at least ten forward speeds and one reverse speed using four planetary gear mechanisms and six engagement elements.

The automatic transmission apparatus of the present invention employs the following means to achieve at least the primary object described above.

An automatic transmission apparatus of the present invention that shifts power input to an input member and outputs the shifted power to an output member is characterized by including:

a first planetary gear mechanism including a first rotational element, a second rotational element, and a third rotational element arranged in this order at intervals corresponding to gear ratios in a velocity diagram;

a second planetary gear mechanism including a fourth rotational element, a fifth rotational element, and a sixth rotational element arranged in this order at intervals corresponding to gear ratios in another velocity diagram;

a third planetary gear mechanism including a seventh rotational element, an eighth rotational element, and a ninth rotational element arranged in this order at intervals corresponding to gear ratios in still another velocity diagram;

a fourth planetary gear mechanism including a tenth rotational element, an eleventh rotational element, and a twelfth rotational element arranged in this order at intervals corresponding to gear ratios in still another velocity diagram;

a first coupling element coupling the first rotational element with the sixth rotational element;

a second coupling element coupling the third rotational element with the eighth rotational element;

a third coupling element coupling the seventh rotational element with the twelfth rotational element;

a fourth coupling element coupling the ninth rotational element with the eleventh rotational element;

a first clutch engaging and disengaging the second rotational element to and from the third coupling element;

a second clutch engaging and disengaging the first coupling element to and from the third coupling element;

a third clutch engaging and disengaging the fifth rotational element to and from the tenth rotational element;

a fourth clutch engaging and disengaging the fourth rotational element to and from the tenth rotational element;

a first brake fixably engaging and disengaging the fourth rotational element to and from an automatic transmission apparatus case; and

a second brake fixably engaging and disengaging the fourth coupling element to and from the automatic transmission apparatus case, in which:

the input member is connected to the fifth rotational element; and

the output member is connected to the second rotational element.

The automatic transmission apparatus of the present invention includes the first planetary gear mechanism including the first rotational element, the second rotational element, and the third rotational element arranged in this order at intervals corresponding to the gear ratios in the velocity diagram; the second planetary gear mechanism including the fourth rotational element, the fifth rotational element, and the sixth rotational element arranged in this order at intervals corresponding to the gear ratios in the other velocity diagram; the third planetary gear mechanism including the seventh rotational element, the eighth rotational element, and the ninth rotational element arranged in this order at intervals corresponding to the gear ratios in still the other velocity diagram; and the fourth planetary gear mechanism including the tenth rotational element, the eleventh rotational element, and the twelfth rotational element arranged in this order at intervals corresponding to the gear ratios in still the other velocity diagram. In the automatic transmission apparatus, the first coupling element couples the first rotational element with the sixth rotational element; the second coupling element couples the third rotational element with the eighth rotational element; the third coupling element couples the seventh rotational element with the twelfth rotational element; and the fourth coupling element couples the ninth rotational element with the eleventh rotational element. The second rotational element is connected to the third rotational element via the first clutch. The first rotational element is connected to the third rotational element via the second clutch. The fifth rotational element is connected to the tenth rotational element via the third clutch. The fourth rotational element is connected to the tenth rotational element via the fourth clutch. Moreover, the first brake connects the fourth rotational element to the automatic transmission apparatus case, and the second brake connects the fourth coupling element to the automatic transmission apparatus case. The input member is connected to the fifth rotational element, and the output member is connected to the second rotational element. In this way, the automatic transmission apparatus can be structured that can function using the four planetary gear mechanisms, the four clutches, and the two brakes.

In the automatic transmission apparatus of the present invention described above, first to tenth forward speeds and a reverse speed can be structured in the following way.

(1) The first forward speed is established by engaging the third clutch, the fourth clutch, and the second brake, and disengaging the first clutch, the second clutch, and the first brake.

(2) The second forward speed is established by engaging the third clutch, the first brake, and the second brake, and disengaging the first clutch, the second clutch, and the fourth clutch.

(3) The third forward speed is established by engaging the fourth clutch, the first brake, and the second brake, and disengaging the first clutch, the second clutch, and the third clutch.

(4) The fourth forward speed is established by engaging the first clutch, the first brake, and the second brake, and disengaging the second clutch, the third clutch, and the fourth clutch.

(5) The fifth forward speed is established by engaging the first clutch, the fourth clutch, and the second brake, and disengaging the second clutch, the third clutch, and the first brake.

(6) The sixth forward speed is established by engaging the first clutch, the fourth clutch, and the first brake, and disengaging the second clutch, the third clutch, and the second brake.

(7) The seventh forward speed is established by engaging the first clutch, the second clutch, and the fourth clutch, and disengaging the third clutch, the first brake, and the second brake.

(8) The eighth forward speed is established by engaging the second clutch, the fourth clutch, and the first brake, and disengaging the first clutch, the third clutch, and the second brake.

(9) The ninth forward speed is established by engaging the second clutch, the third clutch, and the first brake, and disengaging the first clutch, the fourth clutch, and the second brake.

(10) The tenth forward speed is established by engaging the first clutch, the second clutch, and the first brake, and disengaging the third clutch, the fourth clutch, and the second brake.

(11) The reverse speed is established by engaging the second clutch, the third clutch, and the second brake, and disengaging the first clutch, the fourth clutch, and the first brake.

The above-described structure allows the automatic transmission apparatus to perform shifting to each of the first to the tenth forward speeds and the reverse speed using the four planetary gear mechanisms, the four clutches, and the two brakes. As a result, the automatic transmission apparatus of the present invention can have a larger number of forward shift speeds than that of the automatic transmission apparatus of the conventional example that can perform shifting to each of the first to the seventh forward speeds and the reverse speed, thereby providing better fuel economy than that of the automatic transmission apparatus of the conventional example, while achieving all of better fuel economy, better acceleration performance, and better shift feel of the vehicle including the automatic transmission apparatus. The automatic transmission apparatus of the present invention can also perform shifting to optimal gear stages, thereby improving the shift feel.

As described above, each of the first to the tenth forward speeds and the reverse speed is established by engaging three engagement elements and disengaging the other three engagement elements of the six engagement elements including the four clutches and the two brakes, so that the number of the engagement elements to be disengaged can be reduced compared to that of the automatic transmission apparatus of the conventional example that engages two engagement elements and disengages the other four engagement elements of the six engagement elements. The engagement elements generate a drag loss due to slight contact even while disengaged, so that the drag loss reduces the transmission efficiency of power to a lower level as a larger number of engagement elements are disengaged when each of the shift speeds is established. The automatic transmission apparatus of the present invention disengages fewer engagement elements than those of the automatic transmission apparatus of the conventional example, thereby having a higher transmission efficiency of power than that of the automatic transmission apparatus of the conventional example.

The automatic transmission apparatus of the present invention described above can also be characterized in that each of the first, the second, the third, and the fourth planetary gear mechanisms is structured as a single-pinion type planetary gear mechanism having a sun gear, a ring gear, and a carrier as the three rotational elements, in that each of the first, the fourth, the seventh, and the tenth rotational elements is a sun gear, in that each of the second, the fifth, the eighth, and the eleventh rotational elements is a carrier, and in that each of the third, the sixth, the ninth, and the twelfth rotational elements is a ring gear. In other words, all the four planetary gear mechanisms are structured as single-pinion type planetary gear mechanisms. A double-pinion type planetary gear mechanism includes two rows of pinion gears in a radial direction. As a result, the pinion gears mesh with each other, so that the meshing loss of gears is increased, and thus the transmission efficiency of power is reduced compared to the case of the single-pinion type planetary gear mechanisms. Because of having the two rows of pinion gears in the radial direction, the double-pinion type planetary gear mechanism has a larger number of components, lower assemblability, and a lower economic efficiency than in the case of the single-pinion type planetary gear mechanisms. All the four planetary gear mechanisms in the automatic transmission apparatus of the present invention are structured as single-pinion type planetary gear mechanisms. As a result, the automatic transmission apparatus of the present invention can have a higher transmission efficiency of power, better assemblability, a lower cost burden, and a smaller mass than in the case of the automatic transmission apparatus of the conventional example in which three of the four planetary gear mechanisms are structured as single-pinion type planetary gear mechanisms and the remaining one is structured as a double-pinion type planetary gear mechanism.

The automatic transmission apparatus of the present invention can also be characterized in that the second brake is structured as a dog brake. The dog brake is likely to cause a shock when engaged, and hence needs to be synchronously controlled to synchronize the rotation thereof. However, the second brake is engaged at the first forward speed and the reverse speed, and hence is easily controlled because of being synchronously controlled at a low rotational speed. The second brake is continuously engaged at the first to the fifth forward speeds, and is disengaged at the sixth forward speed, which is relatively high-geared, so that employing the dog brake does not impair the shift feel.

### BRIEF DESCRIPTION OF THE DRAWINGS

FIG. 1 is a structural diagram showing an outline of an automatic transmission apparatus 1 of an embodiment.

FIG. 2 is an operation table of the automatic transmission apparatus 1.

FIG. 3 shows velocity diagrams of the automatic transmission apparatus 1.

FIG. 4 is a structural diagram showing an outline of an automatic transmission apparatus 1B of a modification example.

### MODES FOR CARRYING OUT THE INVENTION

Next, a best mode for carrying out the present invention will be described based on an embodiment.

### Embodiment

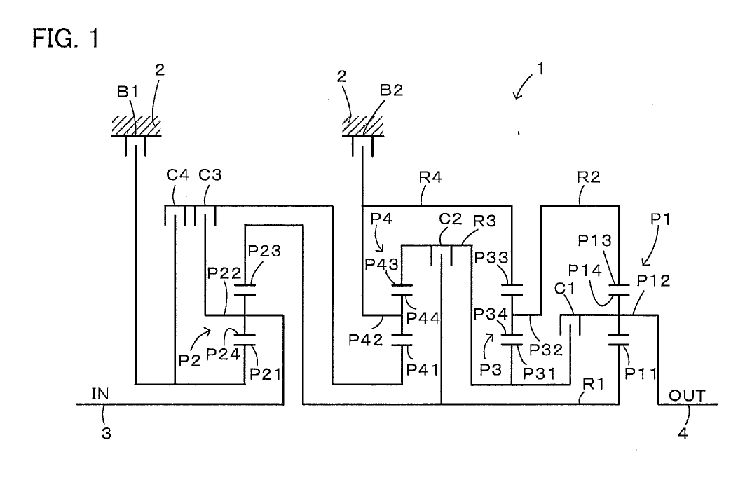

FIG. 1 is a structural diagram showing an outline of an automatic transmission apparatus 1 as an embodiment of the present invention. The automatic transmission apparatus 1 of the embodiment includes four single-pinion type planetary gear mechanisms P1, P2, P3, and P4, four clutches C1, C2, C3, and C4, and two brakes B1 and B2, and is mounted on a vehicle of a type (such as a front-engine rear-drive type) in which an engine as an internal combustion engine (not shown) is longitudinally arranged (in the front-rear direction of the vehicle). The automatic transmission apparatus 1 is structured as a stepped speed change mechanism that receives power from the engine via a starting device, such as a torque converter (not shown) from an input shaft 3, and also shifts the received power to be output to an output gear 4. The power output to the output shaft 4 is output to right and left driving wheels via a gear mechanism and a differential gear (not shown). In the automatic transmission apparatus 1 of the embodiment, the second planetary gear mechanism P2, the third planetary gear mechanism P3, the fourth planetary gear mechanism P4, and the first planetary gear mechanism P1 are arranged in this order from the right side, as shown in FIG. 1.

The first planetary gear mechanism P1 includes a sun gear P11 as an external gear, a ring gear P13 as an internal gear arranged concentrically with the sun gear P11, a plurality of pinion gears P14 meshing with the sun gear P11 and the ring gear P13, and a carrier P12 that is coupled to and also rotatably and revolvably holds the pinion gears P14. The first planetary gear mechanism P1 is structured as a single-pinion type planetary gear mechanism. Hence, the sun gear P11, the ring gear P13, and the carrier P12 as three rotational elements are listed as the sun gear P11, the carrier P12, and the ring gear P13 in the order of arrangement at intervals corresponding to gear ratios in a velocity diagram (listed as the ring gear P13, the carrier P12, and the sun gear P11 in the reverse order). A gear ratio λ1 (the number of teeth of the sun gear P11/the number of teeth of the ring gear P13) of the first planetary gear mechanism P1 is set to, for example, 0.390.

Similar to the first planetary gear mechanism P1, the second planetary gear mechanism P2 is structured as a single-pinion type planetary gear mechanism, and includes, as three rotational elements, a sun gear P21, a ring gear P23, and a carrier P22 that is coupled to and also rotatably and revolvably holds a plurality of pinion gears P24. The sun gear P21, the ring gear P23, and the carrier P22 as the three rotational elements of the second planetary gear mechanism P2 are listed as the sun gear P21, the carrier P22, and the ring gear P23 in the order of arrangement at intervals corresponding to gear ratios in a velocity diagram (listed as the ring gear P23, the carrier P22, and the sun gear P21 in the reverse order). A gear ratio (the number of teeth of the sun gear P21/the number of teeth of the ring gear P23) of the second planetary gear mechanism P2 is set to, for example, 0.395.

Similar to the first and the second planetary gear mechanisms P1 and P2, the third planetary gear mechanism P3 is structured as a single-pinion type planetary gear mechanism, and includes, as three rotational elements, a sun gear P31, a ring gear P33, and a carrier P32 that is coupled to and also rotatably and revolvably holds a plurality of pinion gears P34. The sun gear P31, the ring gear P33, and the carrier P32 as the three rotational elements of the third planetary gear mechanism P3 are listed as the sun gear P31, the carrier P32, and the ring gear P33 in the order of arrangement at intervals corresponding to gear ratios in a velocity diagram (listed as the ring gear P33, the carrier P32, and the sun gear P31 in the reverse order). A gear ratio 23 (the number of teeth of the sun gear P31/the number of teeth of the ring gear P33) of the third planetary gear mechanism P3 is set to, for example, 0.460.

Similar to the first, the second, and the third planetary gear mechanisms P1, P2, and P3, the fourth planetary gear mechanism P4 is structured as a single-pinion type planetary gear mechanism, and includes, as three rotational elements, a sun gear P41, a ring gear P43, and a carrier P42 that is coupled to and also rotatably and revolvably holds a plurality of pinion gears P44. The sun gear P41, the ring gear P43, and the carrier P42 as the three rotational elements of the fourth planetary gear mechanism P4 are listed as the sun gear P41, the carrier P42, and the ring gear P43 in the order of arrangement at intervals corresponding to gear ratios in a velocity diagram (listed as the ring gear P43, the carrier P42, and the sun gear P41 in the reverse order). A gear ratio λ4 (the number of teeth of the sun gear P41/the number of teeth of the ring gear P43) of the fourth planetary gear mechanism P4 is set to, for example, 0.555.

A first coupling element R1 couples the sun gear P11 of the first planetary gear mechanism P1 and the ring gear P23 of the second planetary gear mechanism P2. A second coupling element R2 couples the ring gear P13 of the first planetary gear mechanism P1 and the carrier P32 of the third planetary gear mechanism P3. A third coupling element R3 couples the sun gear P31 of the third planetary gear mechanism P3 and the ring gear P43 of the fourth planetary gear mechanism P4. A fourth coupling element R4 couples the ring gear P33 of the third planetary gear mechanism P3 and the carrier P42 of the fourth planetary gear mechanism P4. The first clutch C1 connects the carrier P12 of the first planetary gear mechanism P1 to the third coupling element R3 (the sun gear P31 of the third planetary gear mechanism P3 and the ring gear P43 of the fourth planetary gear mechanism P4). The second clutch C2 connects the first coupling element R1 (the sun gear P11 of the first planetary gear mechanism P1 and the ring gear P23 of the second planetary gear mechanism P2) to the third coupling element R3 (the sun gear P31 of the third planetary gear mechanism P3 and the ring gear P43 of the fourth planetary gear mechanism P4). The third clutch C3 connects the carrier P22 of the second planetary gear mechanism P2 to the sun gear P41 of the fourth planetary gear mechanism P4. The fourth clutch C4 connects the sun gear P21 of the second planetary gear mechanism P2 to the sun gear P41 of the fourth planetary gear mechanism P4. Moreover, a first brake B1 connects the sun gear P21 of the second planetary gear mechanism P2 to a case 2 of the automatic transmission apparatus 1, and a second brake B2 connects the fourth coupling element R4 (the ring gear P33 of the third planetary gear mechanism P3 and the carrier P42 of the fourth planetary gear mechanism P4) to the case 2 of the automatic transmission apparatus 1. The carrier P22 of the second planetary gear mechanism P2 is connected to the input shaft 3, and the carrier P12 of the first planetary gear mechanism P1 is connected to the output shaft 4. In the embodiment, the four clutches C1, C2, C3, and C4 and the two brakes B1 and B2 are structured as hydraulically driven friction clutches and friction brakes, each of which is engaged by pressing friction plates with a piston.

In this way, in the automatic transmission apparatus 1 of the embodiment, each of the four planetary gear mechanisms P1, P2, P3, and P4 is structured as a single-pinion type planetary gear mechanism. The double-pinion type planetary gear mechanism includes two rows of pinion gears in a radial direction. As a result, the pinion gears mesh with each other, so that the meshing loss of gears is increased, and thus the transmission efficiency of power is reduced compared to the case of the single-pinion type planetary gear mechanisms. Because of having the two rows of pinion gears in the radial direction, the double-pinion type planetary gear mechanism has a larger number of components, lower assemblability, a higher cost burden, and a larger mass than in the case of the single-pinion type planetary gear mechanisms. Each of the four planetary gear mechanisms P1, P2, P3, and P4 in the automatic transmission apparatus 1 of the embodiment is structured as a single-pinion type planetary gear mechanism. As a result, the automatic transmission apparatus 1 can have a higher transmission efficiency of power, better assemblability, a lower cost burden, and a smaller mass than in the case of the automatic transmission apparatus of the conventional example in which three of the four planetary gear mechanisms are structured as single-pinion type planetary gear mechanisms and the remaining one is structured as a double-pinion type planetary gear mechanism.

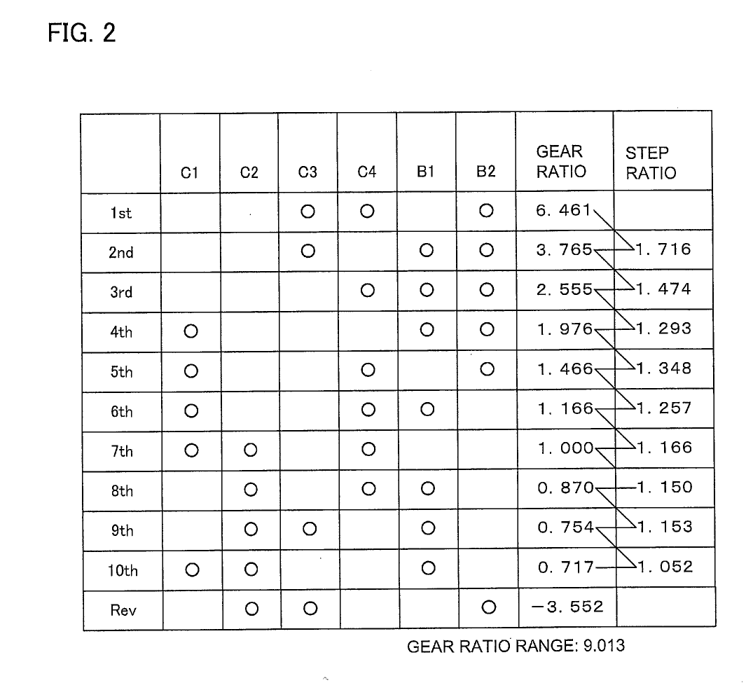

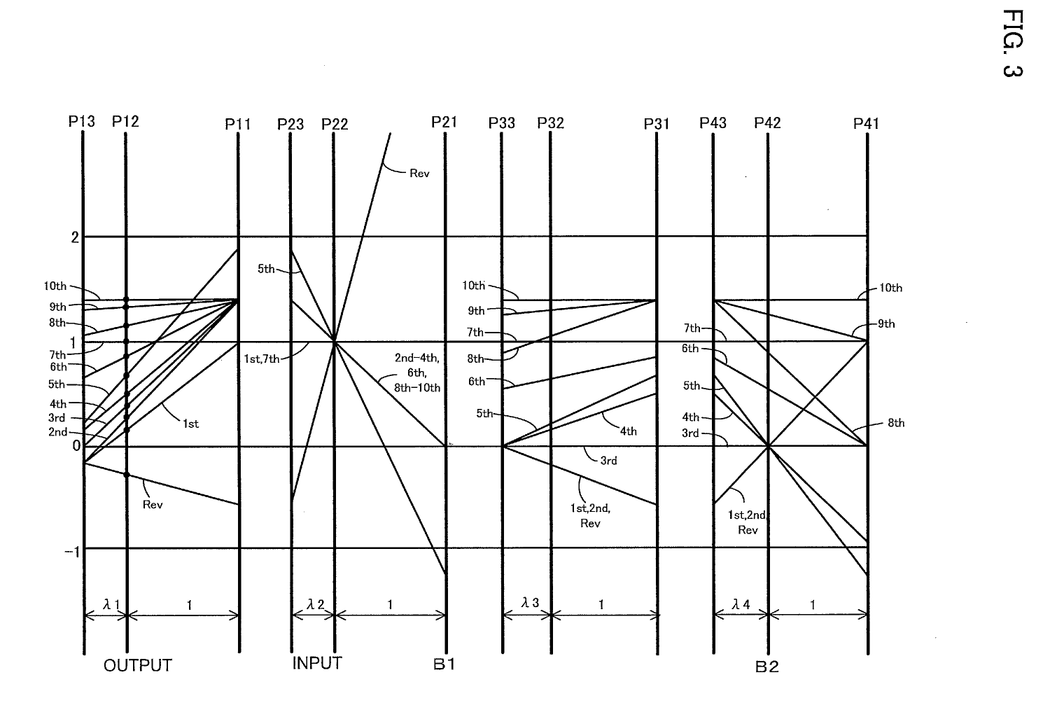

The automatic transmission apparatus 1 of the embodiment thus structured can switch the shift speed in the range of first to tenth forward speeds and a reverse speed, through combinations of engagement and disengagement of the four clutches C1, C2, C3, and C4 and engagement and disengagement of the two brakes B1 and B2. FIG. 2 shows an operation table of the automatic transmission apparatus 1. FIG. 3 shows velocity diagrams of the planetary gear mechanisms P1, P2, P3, and P4 in the automatic transmission apparatus 1. FIG. 3 shows a velocity diagram of the first planetary gear mechanism P1, a velocity diagram of the second planetary gear mechanism P2, a velocity diagram of the third planetary gear mechanism P3, and a velocity diagram of the fourth planetary gear mechanism P4, in this order from the left side. In each of the velocity diagrams, the ring gear, the carrier, and the sun gear are arranged in this order from the left side (in the order of the sun gear, the carrier, and the ring gear from the right side). In FIG. 3, “1st” refers to the first forward speed; “2nd” refers to the second forward speed; “3rd” refers to the third forward speed; “4th” to “10th” refer to the fourth to the tenth forward speeds; and “Rev” refers to the reverse speed. “λ1” to “λ4” refer to the gear ratios of the respective planetary gear mechanisms P1, P2, P3, and P4, and “B1” and “B2” refer to the brakes B1 and B2. “INPUT” refers to a connection position to the input shaft 3, and “OUTPUT” refers to a connection position to the output shaft 4. Values in the velocity diagrams are expressed as ratios obtained by assuming the rotational speed of the input shaft 3 to be 1.000.

As shown in FIG. 2, the automatic transmission apparatus 1 of the embodiment establishes the first to the tenth forward speeds and the reverse speed in the following way. The gear ratios (the rotational speed of the input shaft 3/the rotational speed of the output shaft 4) refer to the case in which 0.390, 0.395, 0.460, 0.555 are used as the gear ratios λ1, λ2, λ3, and λ4 of the four planetary gear mechanisms P1, P2, P3, and P4.

(1) The first forward speed can be established by engaging the third clutch C3, the fourth clutch C4, and the second brake B2 and disengaging the first clutch C1, the second clutch C2, and the first brake B1, and has a gear ratio of 6.461.

(2) The second forward speed can be established by engaging the third clutch C3, the first brake B1, and the second brake B2 and disengaging the first clutch C1, the second clutch C2, and the fourth clutch C4, and has a gear ratio of 3.765.

(3) The third forward speed can be established by engaging the fourth clutch C4, the first brake B1, and the second brake B2 and disengaging the first clutch C1, the second clutch C2, and the third clutch C3, and has a gear ratio of 2.555.

(4) The fourth forward speed can be established by engaging the first clutch C1, the first brake B1, and the second brake B2 and disengaging the second clutch C2, the third clutch C3, and the fourth clutch C4, and has a gear ratio of 1.976.

(5) The fifth forward speed can be established by engaging the first clutch C1, the fourth clutch C4, and the second brake B2 and disengaging the second clutch C2, the third clutch C3, and the first brake B1, and has a gear ratio of 1.466.

(6) The sixth forward speed can be established by engaging the first clutch C1, the fourth clutch C4, and the first brake B1 and disengaging the second clutch C2, the third clutch C3, and the second brake B2, and has a gear ratio of 1.166.

(7) The seventh forward speed can be established by engaging the first clutch C1, the second clutch C2, and the fourth clutch C4 and disengaging the third clutch C3, the first brake B1, and the second brake B2, and has a gear ratio of 1.000.

(8) The eighth forward speed can be established by engaging the second clutch C2, the fourth clutch C4, and the first brake B1 and disengaging the first clutch C1, the third clutch C3, and the second brake B2, and has a gear ratio of 0.870.

(9) The ninth forward speed can be established by engaging the second clutch C2, the third clutch C3, and the first brake B1 and disengaging the first clutch C1, the fourth clutch C4, and the second brake B2, and has a gear ratio of 0.754.

(10) The tenth forward speed can be established by engaging the first clutch C1, the second clutch C2, and the first brake B1 and disengaging the third clutch C3, the fourth clutch C4, and the second brake B2, and has a gear ratio of 0.717.

(11) The reverse speed can be established by engaging the second clutch C2, the third clutch C3, and the second brake B2 and disengaging the first clutch C1, the fourth clutch C4, and the first brake B1, and has a gear ratio of −3.552.

In this way, the automatic transmission apparatus 1 of the embodiment can serve as an automatic transmission apparatus that can perform shifting to each of the first to the tenth forward speeds and the reverse speed using the four planetary gear mechanisms P1, P2, P3, and P4, the four clutches C1, C2, C3, and C4, and the two brakes B1 and B2. As a result, the automatic transmission apparatus 1 of the embodiment can have a larger number of forward shift speeds than that of the automatic transmission apparatus of the conventional example that can perform shifting to each of the first to the seventh forward speeds and the reverse speed. The automatic transmission apparatus 1 of the embodiment has a gear ratio range (the gear ratio of the lowest shift speed (the first forward speed)/the gear ratio of the highest shift speed (the tenth forward speed)) of 6.461/0.717=9.013, and thus can have a larger gear ratio range than that of the automatic transmission apparatus of the conventional example having a gear ratio range of 6.06. As a result, the automatic transmission apparatus 1 of the embodiment can achieve better fuel economy and keep smoother acceleration around the time of shifting than in the case of the automatic transmission apparatus of the conventional example, while achieving better fuel economy, better acceleration performance, and better shift feel of the vehicle including the automatic transmission apparatus 1.

In the automatic transmission apparatus 1 of the embodiment, all the gear stages are established by engaging three engagement elements and disengaging the other three engagement elements of the six engagement elements including the four clutches C1, C2, C3, and C4 and the two brakes B1 and B2, so that the number of the disengaged engagement elements can be smaller than that of the automatic transmission apparatus of the conventional example that engages two engagement elements and disengages the other four engagement elements of the six engagement elements at any shift speed of the first to the seventh forward speeds and the reverse speed. The engagement elements, such as the clutches and the brakes, generate a drag loss due to slight contact even while disengaged, so that the drag loss reduces the transmission efficiency of power to a lower level as a larger number of engagement elements are disengaged when each of the shift speeds is established. The automatic transmission apparatus 1 of the embodiment disengages fewer engagement elements than those of the automatic transmission apparatus of the conventional example, thereby having a higher transmission efficiency of power than that of the automatic transmission apparatus of the conventional example.

The automatic transmission apparatus 1 of the embodiment described above can be structured as an automatic transmission apparatus that can perform shifting to each of at least the first to the tenth forward speeds and the reverse speed by including the four planetary gear mechanisms P1, P2, P3, and P4, the four clutches C1, C2, C3, and C4, and the two brakes B1 and B2, by coupling the sun gear P11 of the first planetary gear mechanism P1 and the ring gear P23 of the second planetary gear mechanism P2 via the first coupling element R1, by coupling the ring gear P13 of the first planetary gear mechanism P1 and the carrier P32 of the third planetary gear mechanism P3 via the second coupling element R2, by coupling the sun gear P31 of the third planetary gear mechanism P3 and the ring gear P43 of the fourth planetary gear mechanism P4 via the third coupling element R3, by coupling the ring gear P33 of the third planetary gear mechanism P3 and the carrier P42 of the fourth planetary gear mechanism P4 via the fourth coupling element R4, and by performing the following operations: connecting the carrier P12 of the first planetary gear mechanism P1 to the third coupling element R3 via the first clutch C1; connecting the first coupling element R1 to the third coupling element R3 via the second clutch C2; connecting the carrier P22 of the second planetary gear mechanism P2 to the sun gear P41 of the fourth planetary gear mechanism P4 via the third clutch C3; connecting the sun gear P21 of the second planetary gear mechanism P2 to the sun gear P41 of the fourth planetary gear mechanism P4 via the fourth clutch C4; connecting the sun gear P21 of the second planetary gear mechanism P2 to the case 2 of the automatic transmission apparatus 1 via the first brake B1; connecting the fourth coupling element R4 to the case 2 of the automatic transmission apparatus 1 via the second brake B2; connecting the carrier P22 of the second planetary gear mechanism P2 to the input shaft 3; and connecting the carrier P12 of the first planetary gear mechanism P1 to the output shaft 4.

In the automatic transmission apparatus 1 of the embodiment, each of the four planetary gear mechanisms P1, P2, P3, and P4 is structured as a single-pinion type planetary gear mechanism. As a result, the automatic transmission apparatus 1 can have a higher transmission efficiency of power, better assemblability of the apparatus, a lower cost burden, and a smaller mass than in the case of the automatic transmission apparatus of the conventional example in which three of the four planetary gear mechanisms are structured as single-pinion type planetary gear mechanisms and the remaining one is structured as a double-pinion type planetary gear mechanism.

Moreover, the automatic transmission apparatus 1 of the embodiment has the gear ratio range of 9.013 by using 0.390, 0.395, 0.460, and 0.555 as the gear ratios λ1, λ2, λ3, and λ4 of the four planetary gear mechanisms P1, P2, P3, and P4, thereby having a larger gear ratio range than that of the automatic transmission apparatus of the conventional example having a gear ratio range of 6.06, As a result, the fuel economy of the vehicle including the automatic transmission apparatus can be enhanced, and acceleration and deceleration feeling around the time of shifting can also be improved compared to the case of the automatic transmission apparatus of the conventional example.

In addition, the automatic transmission apparatus 1 of the embodiment establishes each of the first to the tenth forward speeds and the reverse speed by engaging three engagement elements and disengaging the other three engagement elements of the six engagement elements including the four clutches C1, C2, C3, and C4 and the two brakes B1 and B2, so that the number of the disengaged engagement elements can be smaller than that of the automatic transmission apparatus of the conventional example that engages two engagement elements and disengages the other four engagement elements of the six engagement elements at any shift speed of the first to the seventh forward speeds and the reverse speed. As a result, the transmission efficiency of power can be higher than that of the automatic transmission apparatus of the conventional example.

The automatic transmission apparatus 1 of the embodiment is to be mounted on the front-engine rear-drive vehicle. The automatic transmission apparatus may, however, be mounted on a vehicle of another type (such as a front-engine front-drive type) in which the engine is transversely arranged (in the right-left direction of the vehicle).

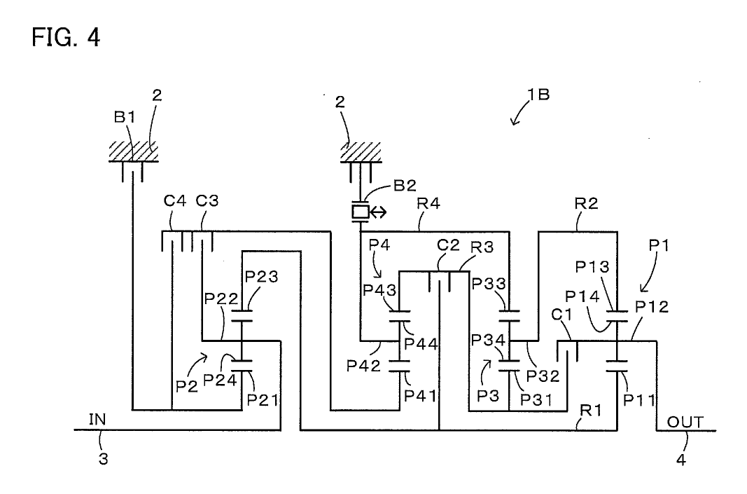

In the automatic transmission apparatus 1 of the embodiment, all the four clutches C1, C2, C3, and C4 are structured as friction clutches, and both of the two brakes B1 and B2 are structured as friction brakes. However, some of the clutches and the brakes may be structured as dog clutches and dog brakes, instead of the friction clutches and the friction brakes. FIG. 4 shows an automatic transmission apparatus 1D of still another modification example modified from the automatic transmission apparatus 1. In the automatic transmission apparatus 1D, the second brake B2 is structured as a dog brake. The operation table and the velocity diagrams of the automatic transmission apparatus 1B of still the other modification example are the same as those of FIGS. 2 and 3. The dog brake is likely to cause a shock when engaged, and hence needs to be synchronously controlled to synchronize the rotation thereof. However, the second brake is engaged at the first forward speed and the reverse speed, and hence is easily controlled because of being synchronously controlled at a low rotational speed. The second brake is continuously engaged at the first to the fifth forward speeds, and is disengaged at the sixth forward speed, which is relatively high-geared, so that employing the dog brake does not impair the shift feel.

In the automatic transmission apparatus 1 of the embodiment, 0.390, 0.395, 0.460, and 0.555 are used as the gear ratios λ1, λ2, λ3, and λ4 of the four planetary gear mechanisms P1, P2, P3, and P4. The gear ratios λ1, λ2, λ3, and λ4 are, however, not limited to these values.

In the automatic transmission apparatus 1 of the embodiment, each of the four planetary gear mechanisms P1, P2, P3, and P4 is structured as a single-pinion type planetary gear mechanism. However, some or all of the four planetary gear mechanisms P1, P2, P3, and P4 may be structured as double-pinion type planetary gear mechanisms.

The automatic transmission apparatus 1 of the embodiment is structured as an automatic transmission apparatus that can establish the first to the tenth forward speeds and the reverse speed by engaging three engagement elements and disengaging the other three engagement elements of the six engagement elements including the four clutches C1, C2, C3, and C4 and the two brakes B1 and B2. The automatic transmission apparatus 1 may be an automatic transmission apparatus that can establish first to eleventh forward speeds and the reverse speed by providing a shift speed having a gear ratio of 0.805 between the eighth forward speed and the ninth forward speed in the automatic transmission apparatus 1 of the embodiment, the provided shift speed being established by engaging the first clutch C1, the third clutch C3, and the first brake B1, and disengaging the second clutch C2, the fourth clutch C4, and the second brake B2.

The following describes the correspondence between the main elements of the embodiment and the main elements of the invention described in the Summary of the Invention. In the embodiment, the input shaft 3 corresponds to an “input member”, and the output shaft 4 to an “output member”; the first planetary gear mechanism P1 corresponds to a “first planetary gear mechanism”, the sun gear P11 to a “first rotational element”, the carrier P12 to a “second rotational element”, and the ring gear P13 to a “third rotational element”; the second planetary gear mechanism P2 corresponds to a “second planetary gear mechanism”, the sun gear P21 to a “fourth rotational element”, the carrier P22 to a “fifth rotational element”, and the ring gear P23 to a “sixth rotational element”; the third planetary gear mechanism P3 corresponds to a “third planetary gear mechanism”, the sun gear P31 to a “seventh rotational element”, the carrier P32 to an “eighth rotational element”, and the ring gear P33 to a “ninth rotational element”; the fourth planetary gear mechanism P4 corresponds to a “fourth planetary gear mechanism”, the sun gear P41 to a “tenth rotational element”, the carrier P42 to an “eleventh rotational element”, and the ring gear P43 to a “twelfth rotational element”; the first coupling element R1 corresponds to a “first coupling element”, the second coupling element R2 to a “second coupling element”, the third coupling element R3 to a “third coupling element”, and the fourth coupling element R4 to a “fourth coupling element”; the first clutch C1 corresponds to a “first clutch”, the second clutch C2 to a “second clutch”, the third clutch C3 to a “third clutch”, and the fourth clutch C4 to a “fourth clutch”; and the first brake B1 corresponds to a “first brake”, and the second brake B2 to a “second brake”. With regard to the correspondence between the main elements of the embodiment and the main elements of the invention described in the Summary of the Invention, the embodiment is only an example for giving a specific description of a best mode for carrying out the invention explained in the Summary of the Invention. This correspondence does not limit the elements of the invention described in the Summary of the Invention. In other words, the invention described in the Summary of the Invention should be interpreted based on the description in that section, and the embodiment is only a specific example of the invention described in the Summary of the Invention.

While the best modes for carrying out the present invention have been described above using the embodiment, the present invention is not limited to the embodiment, but can be obviously implemented in various forms within the scope not deviating from the gist of the present invention.

### INDUSTRIAL APPLICABILITY

The present invention can be used in, for example, industries for manufacturing automatic transmission apparatuses.

1. An automatic transmission apparatus that shifts power input to an input member and outputs the shifted power to an output member, the automatic transmission apparatus comprising:
a first planetary gear mechanism including a first rotational element, a second rotational element, and a third rotational element arranged in this order at intervals corresponding to gear ratios in a velocity diagram;
a second planetary gear mechanism including a fourth rotational element, a fifth rotational element, and a sixth rotational element arranged in this order at intervals corresponding to gear ratios in a velocity diagram;
a third planetary gear mechanism including a seventh rotational element, an eighth rotational element, and a ninth rotational element arranged in this order at intervals corresponding to gear ratios in a velocity diagram;
a fourth planetary gear mechanism including a tenth rotational element, an eleventh rotational element, and a twelfth rotational element arranged in this order at intervals corresponding to gear ratios in a velocity diagram;
a first coupling element coupling the first rotational element and the sixth rotational element;
a second coupling element coupling the third rotational element and the eighth rotational element;
a third coupling element coupling the seventh rotational element and the twelfth rotational element;
a fourth coupling element coupling the ninth rotational element and the eleventh rotational element;
a first clutch engaging and disengaging the second rotational element to and from the third coupling element;
a second clutch engaging and disengaging the first coupling element to and from the third coupling element;
a third clutch engaging and disengaging the fifth rotational element to and from the tenth rotational element;
a fourth clutch engaging and disengaging the fourth rotational element to and from the tenth rotational element;
a first brake fixably engaging and disengaging the fourth rotational element to and from an automatic transmission apparatus case; and
a second brake fixably engaging and disengaging the fourth coupling element to and from the automatic transmission apparatus case, wherein:
the input member is connected to the fifth rotational element; and
the output member is connected to the second rotational element.

2. The automatic transmission apparatus according to claim 1, wherein
a first forward speed is established by engaging the third clutch, the fourth clutch, and the second brake, and disengaging the first clutch, the second clutch, and the first brake,
a second forward speed is established by engaging the third clutch, the first brake, and the second brake, and disengaging the first clutch, the second clutch, and the fourth clutch,
a third forward speed is established by engaging the fourth clutch, the first brake, and the second brake, and disengaging the first clutch, the second clutch, and the third clutch,
a fourth forward speed is established by engaging the first clutch, the first brake, and the second brake, and disengaging the second clutch, the third clutch, and the fourth clutch,
a fifth forward speed is established by engaging the first clutch, the fourth clutch, and the second brake, and disengaging the second clutch, the third clutch, and the first brake,
a sixth forward speed is established by engaging the first clutch, the fourth clutch, and the first brake, and disengaging the second clutch, the third clutch, and the second brake,
a seventh forward speed is established by engaging the first clutch, the second clutch, and the fourth clutch, and disengaging the third clutch, the first brake, and the second brake,
an eighth forward speed is established by engaging the second clutch, the fourth clutch, and the first brake, and disengaging the first clutch, the third clutch, and the second brake,
a ninth forward speed is established by engaging the second clutch, the third clutch, and the first brake, and disengaging the first clutch, the fourth clutch, and the second brake,
a tenth forward speed is established by engaging the first clutch, the second clutch, and the first brake, and disengaging the third clutch, the fourth clutch, and the second brake, and
a reverse speed is established by engaging the second clutch, the third clutch, and the second brake, and disengaging the first clutch, the fourth clutch, and the first brake.

3. The automatic transmission apparatus according to claim 2, wherein
each of the first, the second, the third, and the fourth planetary gear mechanisms is structured as a single-pinion type planetary gear mechanism having a sun gear, a ring gear, and a carrier as three rotational elements,
each of the first, the fourth, the seventh, and the tenth rotational elements is a sun gear,
each of the second, the fifth, the eighth, and the eleventh rotational elements is a carrier, and
each of the third, the sixth, the ninth, and the twelfth rotational elements is a ring gear.

4. The automatic transmission apparatus according to claim 3, wherein the second brake is structured as a dog brake.

5. The automatic transmission apparatus according to claim 1, wherein
each of the first, the second, the third, and the fourth planetary gear mechanisms is structured as a single-pinion type planetary gear mechanism having a sun gear, a ring gear, and a carrier as three rotational elements,
each of the first, the fourth, the seventh, and the tenth rotational elements is a sun gear,
each of the second, the fifth, the eighth, and the eleventh rotational elements is a carrier, and
each of the third, the sixth, the ninth, and the twelfth rotational elements is a ring gear.

6. The automatic transmission apparatus according to claim 5, wherein the second brake is structured as a dog brake.
